(19) United States
(12) Patent Application Publication
(10) Pub. No.: US 2024/0176948 A1
(43) Pub. Date: May 30, 2024

(54) METHOD & SYSTEM FOR LABELING AND ORGANIZING DATA FOR SUMMARIZING AND REFERENCING CONTENT VIA A COMMUNICATION NETWORK

(71) Applicant: PowerNotes LLC, Chicago, IL (US)

(72) Inventors: Wilson TSU, Chicago, IL (US); Srujani PAGIDIPATI, Chicago, IL (US)

(21) Appl. No.: 18/408,285

(22) Filed: Jan. 9, 2024

Related U.S. Application Data
(63) Continuation of application No. 16/536,152, filed on Aug. 8, 2019, now Pat. No. 11,868,708.
Application No. 16/536,152 is a continuation of application No. 14/215,843, filed on Mar. 17, 2014, now Pat. No. 11,763,070.
(60) Provisional application No. 61/793,717, filed on Mar. 15, 2013.

(51) Int. Cl. G06F 40/169; G06F 16/38

(52) U.S. Cl. CPC G06F 40/169; G06F 16/382

(57) ABSTRACT

Systems and methods of the present technology generally provide computer implemented assistance for data summary, including organizing and generating a summary of data selected form source documents. A data set of user-identified information from one or more source documents and custom information may be received and processed by a data summary system. The system may analyze and prioritize the user-identified information and any custom information, and generate a formatted summary that includes the user-identified information and the custom information. The system server may then provide the summary via a communication link to a client device.

### RELATED APPLICATIONS

This application is a continuation of U.S. patent application Ser. No. 16/536,152 filed on Aug. 8, 2019, currently pending, which claims priority to U.S. patent application Ser. No. 14/215,843 filed on Mar. 17, 2014, which claims priority to U.S. Provisional Application Ser. No. 61/793,717, filed on Mar. 15, 2013, and the disclosure of which are hereby incorporated by reference in their entirety.

### FIELD OF THE INVENTION

The present technology generally relates to computer-aided data summary systems and methods that assist users with analyzing data and, more particularly, to a method and system for obtaining, analyzing, labeling, organizing, combining, modifying, and/or summarizing data using single- and multi-action operations.

### BACKGROUND

Professionals and students often require the analysis and manipulation of data and information. Such individuals may practice or study in, without limitation, the fields of law, business, finance, medicine, legal education, business education, medical education, graduate education, undergraduate education, and K-12 education.

Existing technology generally requires users to: (i) either obtain pre-sorted data in excess of usability requirements or manually search for, gather, and organize multiple documents from various sources, (ii) obtain and utilize several tools to label and annotate such data, and/or (iii) manually organize, integrate, and summarize the original data with user-created data.

A need exists for a system and/or method that organizes information from multiple sources, allows users to easily and efficiently label such information, allows users to modify such information, allows users to combine and separate such information with other information, and displays all such information in a user-friendly format. Such a system, by automating and streamlining many labor-intensive steps involved in the above processes, would reduce the amount of work for and increase the efficiency of, users.

The systems and methods of the present technology can be used to automate and streamline many of these steps involved in these processes, through, but not limited to, single-action functionality.

### SUMMARY OF THE INVENTION

Examples of the present technology can include components of a cloud-based (or other Internet-based) or device-based (such as a personal computer, tablet, smartphone, or other device) platform that provides a user with a streamlined interface/display with the functionality to display, label, organize, integrate, modify, and/or summarize information. Additional functionality includes, but is not limited to, simplified information selection, copying, cutting and pasting labeling/tagging, separation of annotations from information, integration of information, sorting through and displaying similar information or distinguishing dissimilar information, and other functions, either through single-action operation or otherwise, to provide an efficient user experience.

In one aspect, a data summary system is provided that includes a user device with a processor and an input device. The system server may include a system memory configured to store program instructions and a system processor configured to execute the program instructions. When executed, the program instructions may cause the system processor to receive a first data set. The first data set may include a user identifier, user-identified information, and custom information. The user-identified information may include text selected from a source document. The system processor can store the user-identified information and the custom information in the system memory at a location associated with the user identifier. The system can generate a summary in response to a user command received via the input device. The summary may include the user-identified information and the custom information. An output can be generated in a split screen format with the source document and the summary.

In another aspect, the custom information is prioritized relative to the user-identified information, such that the custom information is displayed above the user-identified information in the summary. In some forms, the data summary system further includes a link between the user-identified information in the summary and the source document. In some embodiments, the data summary system further includes a unique identifier associated with the user-identified information and may be selected from a unique identifier selection box. In some aspects, the first data set further includes custom information associated with the unique identifier. The summary can be formatted to include the custom information listed underneath the unique identifier. The data summary system can also link the user-identified information of the summary to corresponding original information of the source document. In some forms, the output generated includes a notes area for a user to input additional information. In some aspects, the split screen format is generated in response to receiving a user selection indicating that the split screen format is selected.

In another aspect, a method for generating a data system summary is provided. The method includes receiving a first data set by a processor of a system service. The first data set can include a user identifier, user-identified information, and custom information. The user-identified information can include text selected from a source document. The user-identified information and the custom information can be stored in a system memory of the system server at a location associated with the user identifier. A summary can be generated in response to a user command. The summary can include the user-identified information and the custom information. The summary can be provided in a split screen view with the source document.

In some aspects, the method can also include receiving an initial interaction from a client device that is coupled to the system server via the communication link. The user identifier can be assigned and sent to the client device in response to the initial interaction. The user identifier associates the client device with a user profile stored in the system memory. The method can further include receiving a unique identifier with the first data set. The unique identifier is associated with the text selected from the source document and is selected from a unique identifier selection box. In some aspects, the custom information is associated with the unique identifier. The summary can include the custom information listed under the unique identifier. In some forms, The program instructions may cause the processor to process hyper-text transfer protocol (HTTP) requests received via the communication link. The program instructions may cause the processor to provide requested web pages of the multiple web pages included in the website database via the communication link. The requested web pages may be defined in the HTTP requests. The processor can identify the requested web pages and provide the requested web pages in response to the HTTP requests. In some forms, the custom information is prioritized in the summary relative to the user-identified information, such that the custom information is listed above the user-identified information in the summary. In some embodiments, the program instructions may cause the processor to link the user-identified information of the summary to corresponding original information of the source document.

In another aspect, a data summary system is provided. The data summary system includes a user device with a user device processor and an input device. The data summary system also includes a system server with a system memory and a system processor. The system memory is configured to store program instructions and the system processor is configured to execute the program instructions. When the program instructions are executed, the system process can receive a first data set via a communication link. The first data set can include a user-identifier, a first user-identified information, and a first custom information. The first user-identified information can include a first text selected from a first source document. The system processor can also be configured to receive a second data set via the communication link. The second data set can include the user-identifier, a second user-identified information, and a second custom information. The second user-identified information can include a second text selected from a second source document. The system processor can store the first user-identified information, the first custom information, the second user-identified information, and the second custom information in the system memory associated with the user identifier. A first summary can be generated with the first user-identified information and the first custom information. A second summary can be generated with the second user-identified information and the second custom information. An output can be generated in a split screen format. The split screen can include the first source document the second source document on a first side, and the first summary and the second summary on the second side.

In some aspects, the first data set includes a first unique identifier being associated with the first text and being selected from a first unique identifier selection box. The second data set includes a second unique identifier being associated with the second text and being selected from the second unique identifier selection box. In some forms, the first summary is generated to include the first custom information underneath the first unique identifier. The second summary is generated to include the second custom information underneath the second unique identifier. In some embodiments, the system processor aggregates the first summary and the second summary to produce an aggregated summary. The aggregated summary can be provided via the communication link. In some aspect, the system processor can link the first data set of the first user-identified information of the first summary to corresponding original information of the first source document. The system processor can also link the second data set of the second user-identified information of the second summary to the corresponding original information of the second source document.

### BRIEF DESCRIPTION OF THE DRAWINGS

Specific examples have been chosen for purposes of illustration and description, and are shown in the accompanying drawings, forming a part of the specification.

FIG. 1 illustrates a diagram of hardware system components for one example of a data summary system of the present technology.

FIG. 2 illustrates a diagram of one example of software system components that can be used in the system of FIG. 1.

FIG. 3 illustrates a flow chart of one embodiment of a data summary method of the present technology.

FIG. 4 illustrates one embodiment of how a user could associate user-identified information with a unique identifier.

FIG. 5 illustrates one example of user-identified information before single-action operation.

FIG. 6 illustrates one example of a summary created by single-action operation.

FIG. 7 illustrates one embodiment of how a user can aggregate, manipulate, and distinguish information from multiple summaries.

FIG. 8 illustrates a merged view showing one embodiment of the linking between FIGS. 1 & 2.

FIG. 9 illustrates a flow chart of one embodiment of the merging summary data with original content.

### DETAILED DESCRIPTION

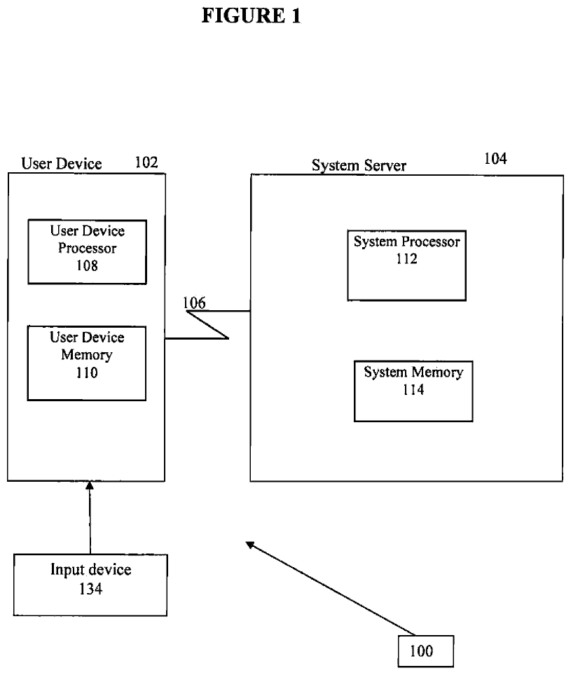

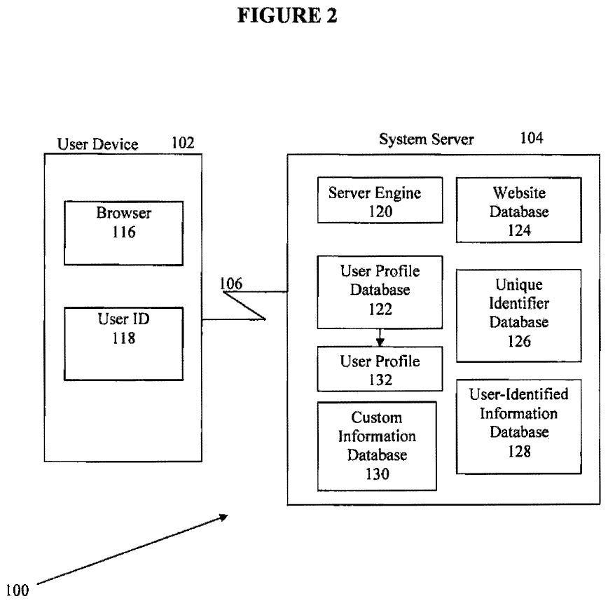

FIGS. 1 and 2 illustrates an embodiment of the system architecture of one example of a data summary system 100 of the present technology. As shown in FIGS. 1 and 2, the data organizing system includes at least one user device 102 and at least one system server 104, and a communication link 106, through which the user device 102 and system server 104 are operatively connected. The term “operatively connected” as used herein means that the at least one user device 102 and the at least one system server 104 can send and receive data to one another through the communication link 106. The communication link 106 can include a wired connection or a wireless connection, and can be via a local area network (LAN) connection, or via a wide area network (WAN) connection, such as the Internet.

The hardware components of each of the user device 102 and the system server 104 include at least one processor, and at least one non-transient computer readable storage medium, such as a memory. As shown in FIG. 1, the user device 102 includes at least one user device processor 108 and at least one user device memory 110, and the system server includes at least one system processor 112 and at least one system memory 114. The user device 102 can also include an input device 134, that the user can use to input commands to the user device 102, such as selection of user-identified information. The input device 134 can include one or more of a keyboard, a mouse, an electronic pointing device, a touch screen, or any other suitable device.

Examples of system architecture components of each of the user device 102 and the system server 104 are illustrated in FIG. 2.

As shown, the user device 102 includes a browser 116, which is assigned a unique user identifier 118. The user identifier 118 is an identifier that identifies the user device 102 to the server system 104. The user identifier may be stored in a file referred to as a “cookie.” In one example, the server system 104 can assign and send the user identifier 118 to the user device 102 once, when the user device 102 first interacts with the server system 104. Once the user device 102 receives the user identifier 118, the user device stores the user identifier 118, such as in the user device memory 110, and provides it with every message sent to the server system 104. The server system 104, which can have communication links with any number of user devices, can thus identify the user device 102 as being the source of the message.

As also shown in FIG. 2, the system server 104 can include a server engine 120, user profile database 122 including a stored user profile 132 associated with each user identifier, a website database 124 including web pages, a unique identifier database 126, a user-identified information database 128, and a custom information database 130. Each database of the server system 104 can be stored in the system memory 114. The server engine 120 can include at least the system processor 112.

In the illustrated example, the server system 104 associates, and operatively links, each user identifier 118 with a user profile 132 stored in the user profile database 122, unique identifiers, user-identified information identified by the user device 102, and custom information received from the user device 102.

In some examples, the server engine 120 receives HTTP requests from a user device 102 to access web pages identified by URLs, and provides the requested web pages from the website database 124 to the user device 102. However, one of ordinary skill in the art would appreciate that the summary techniques described herein could be used in various environments other than the Internet. For example, the summaries could also be in an electronic mail environment. Also, a server system 104 or user device 102 may include any combination of hardware or software suitable for performing the methods described herein. For example, a user device 102 may comprise any combination of hardware or software that can interact with the server system 104. Either the user device 102 or the server system 104 can include one or more handheld devices, personal computers or television- or tablet-based systems, or various consumer computer products through which information may be generated.

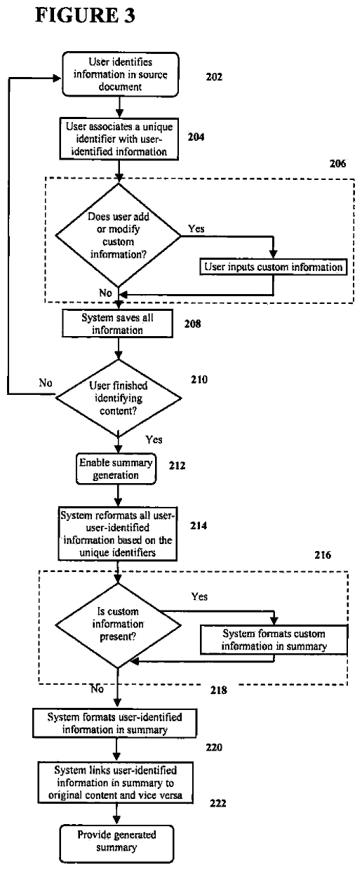

FIG. 3 illustrates one example of a data summary method of the present technology. At step 202, a user uses the user device 102 to identify user-identified information in a source document. The source document can be any electronic document, such as digital text, media, web pages, or other content to be included in the summary. The user can identify the user-identified information by selecting a subset of text in a source document, such as by highlighting the text and clicking a mouse to select the text. Once the user has selected the user-identified information, the user may be prompted to associate such user-identified information with a unique identifier. At step 204, the user associates a unique identifier with the user-identified information. The user can select the unique identifier associated with the user-identified information from a plurality of predefined unique identifiers, such as a listing of unique identifiers presented in a drop-down menu. Alternatively, the unique identifiers can be customized by the user. At step 206, the summary system allows the user to input or modify additional custom information under the unique identifier. The user device 102 then sends a first data set to the server system 104 via the communication link 106. The first data set includes the user identifier 118, the user-identified information, and the unique identifier associated with the user-identified information. The server system 104 receives the first dataset, recognizes the user identifier, and stores the user-identified information in the user's profile. If the user did not input or modify additional custom information, the server system 104 saves the user-identified information under the unique identifier chosen by the user. However, if the user did modify or input custom information, the server system 104 saves the new or modified custom information, along with the user-identified information.

At step 210, the summary system determines whether the user is done creating user-identified information. If the user is not done, the method repeats steps 202 through 208, with the user selecting user-identified information from any one or more source documents, which can be the same or different from the original source document and each other. If the user has completed identifying user-identified information, the method progresses to step 212.

At step 212, the server system enables the generation of a data summary. In some examples, the user can cause the server system 104, or the user device 102, to generate the summary with a single action. For example, the user can enter a single command, such as a mouse click on a button in a selection box displayed by the user device 102, which the user device 102 sends to the system server 104, in order to cause the server system 104 to create a summary of the user-identified information and any custom information. In an example where the user device is being used offline, the user can enter the single command in order to cause the user device 102 to create a summary of the user-identified information and any custom information. If the user enters the command, summary system 100 proceeds to step 214, where the summary system 100, either through the server system 104 or the user device 102, reformats the user-identified information and the associated unique identifier, and reformats the information in order to generate a summary. Generating a summary includes prioritizing and formatting the information received from the user. For example, if custom information is present under a unique identifier, the summary system 100 can format the custom information in the summary, including prioritizing the custom information relative to, such as above or below, the user-identified information for any given unique identifier at step 216. Additionally, at step 218, the system formats the user-identified information into the summary. In generating the summary, the summary system 100 can link the summarized information to the original information and vice versa at step 220. Finally, at step 222, the summary system 100 can provide the generated summary to the user. If the server system 104 generated the summary, the summary can be provided to the user by sending the generated summary to the user device 102 via the communication link 106.

In examples where the user can cause the summary to be generated with a single action, once the user initiates the single-action (via a mouse click, keystroke, or otherwise), the system generates a formatted summary. The summary system 100 can also allow the user to modify the generated summary. In general, the user need only enter the user-identified information, and any custom information, under each unique identifier, and then execute the single action in order to generate a summary. Such systems can allow the user to efficiently and reliably generate a summary of digital text, media, web pages, or other content.

In alternative examples, a multi-action operation can be used, which can include defining a custom summary format through multiple mouse clicks and/or keystrokes prior to generating the summary.

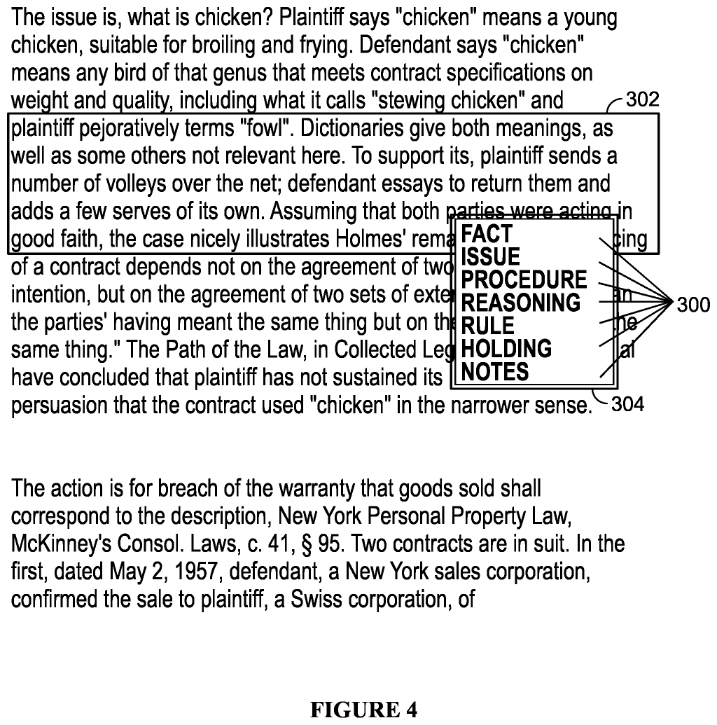

FIG. 4 illustrates one embodiment of how the user can assign a unique identifier 300 to a selection of user-identified information 302. In this example, once the user-identified information 302 is selected by the user, a unique identifier selection box 304 is displayed by the user device 102, providing the user with various predefined or common unique identifiers 300. These may include, as examples only, Fact, Issue, Procedure, Reasoning, Rule, Holding, Notes. The user can then select the unique identifier 300 to be associated with the user-identified information 302 through a single action (via a mouse click or otherwise) or multiple actions. Once a particular unique identifier 300 is selected by the user (via a mouse click or otherwise), the summary system 100 associates that unique identifier 300 with the particular selection of user-identified information 302, and saves such association for possible further processing. The summary system 100 can allow the user to modify and customize the unique identifiers 300 and the unique identifier selection box 304.

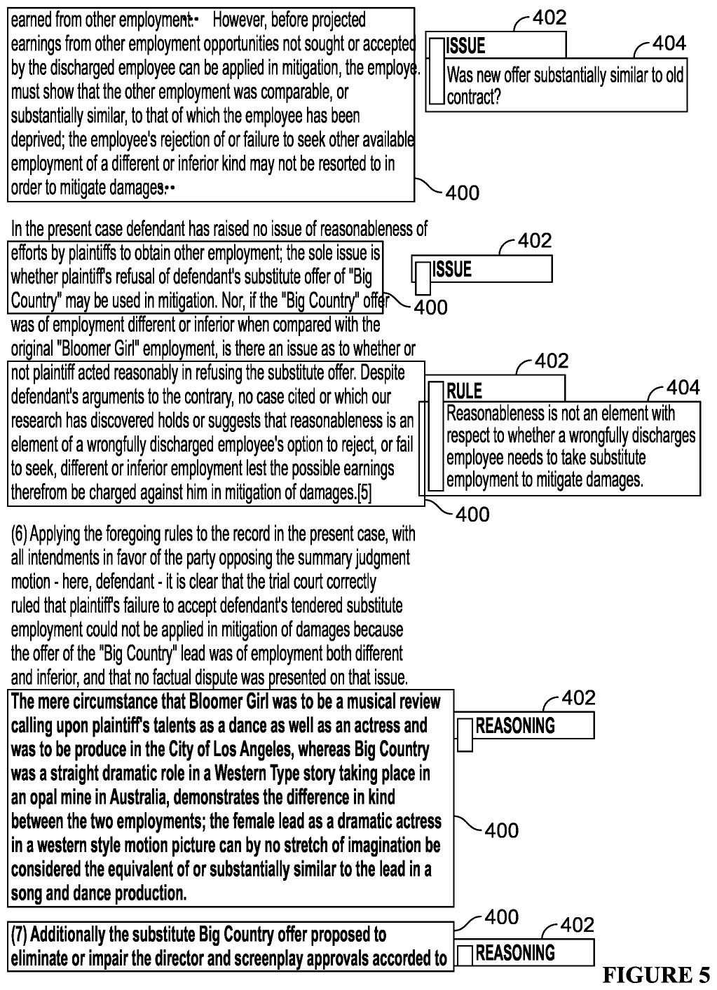

FIG. 5 illustrates one example of content where the user has identified user-identified information 400, and associated the user-identified information 400 with unique identifiers 402 and the system has saved such information under the user's profile. In some instances, the user has input custom information 404 under the unique identifiers. The summary system 100 stores the user-identified information 400, the unique identifiers 402, and the custom information 404 in the system server 104 in association with the user identifier 118.

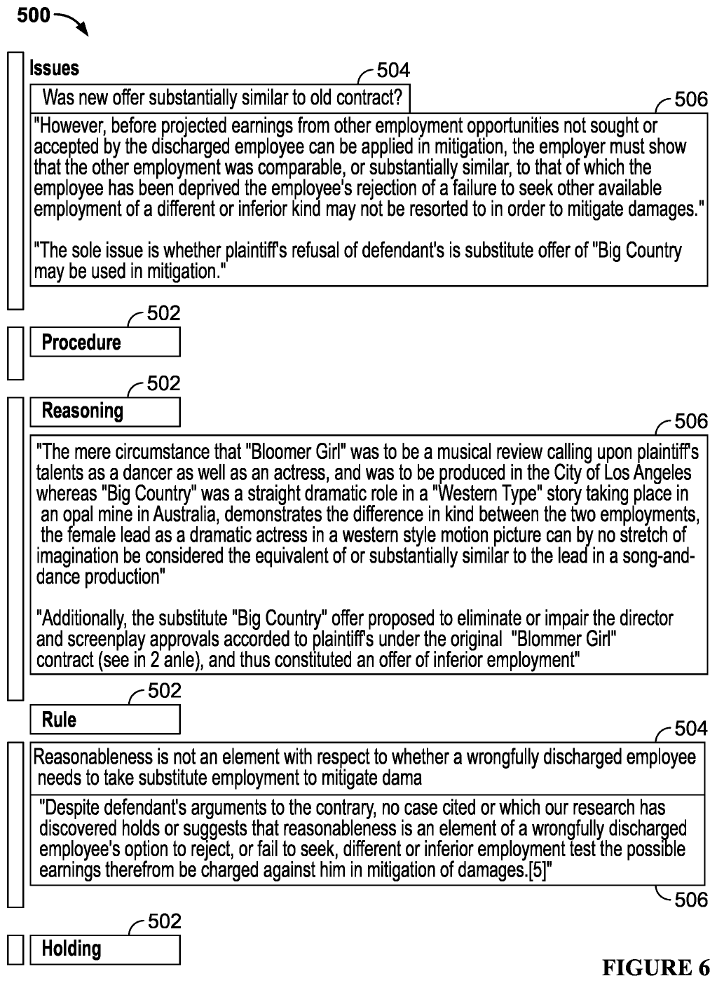

FIG. 6 illustrates one example of a summary 500 generated by the system server 104 of the summary system 100. The summary 500 includes a listing of each unique identifier 502. Under each unique identifier 502, any custom information 504 and user-identified information 506 associated with the unique identifier 502 are listed. The custom information 504 is illustrated as being prioritized over the user-identified information 506 for each unique identifier 502. The system can, however, be customized to prioritize custom and user-identified information in any order.

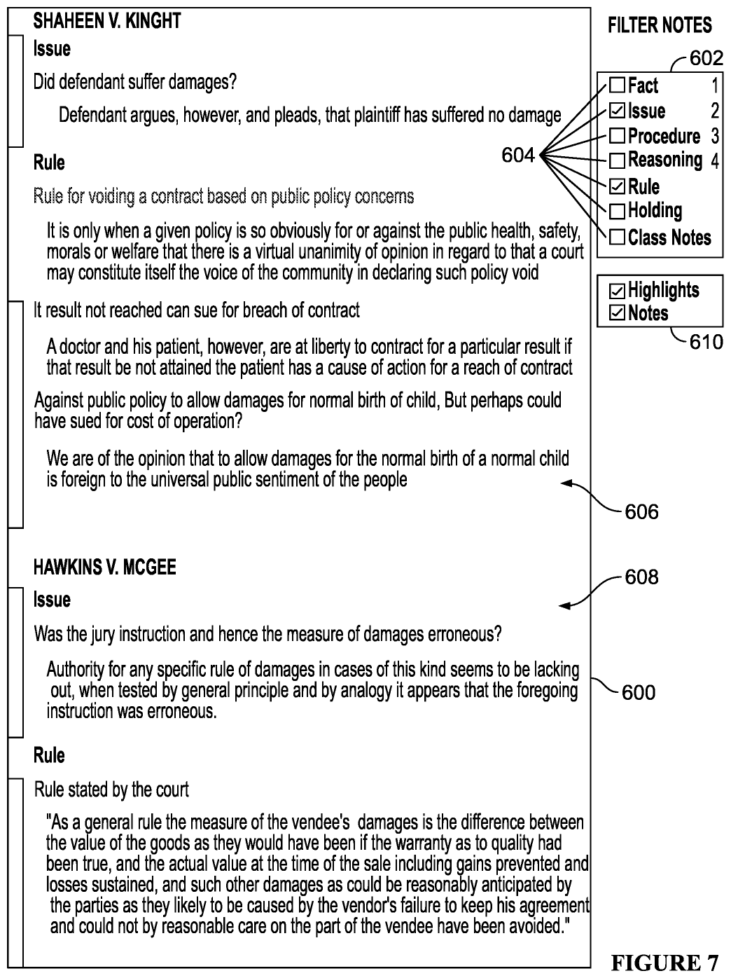

The summary system 100 can also aggregate multiple summaries, and allow the user to view user-identified information and/or custom information by unique identifier across multiple summaries. FIG. 7 illustrates one example of how multiple summaries 600 can be aggregated and how unique identifiers can be used to filter and/or distinguish information from multiple summaries. In this example, a unique identifier activation box 602 is used to allow the user to select desired unique identifiers 604, by checking the indicated selection box(es). The summary system 100 generates a display of all of the user-identified information 606 and custom information 608 associated with the selected unique identifiers 602. An information type selection box 610 can be used to display user-identified information 606, custom information 608, or both. In this example, the information type selection box 610 differs from the unique identifier activation box 602 in that the information type selection box 610 allows the user to choose to display either user-identified information 606 or custom information 608, or both, across multiple summaries, while the unique identifier activation box 602 allows the user to choose to display information (either user-identified information 606 or custom information 608, or both) associated with certain unique identifiers (and exclude others) across multiple summaries 600. Thus, a compilation of summaries can be created by the summary system 100.

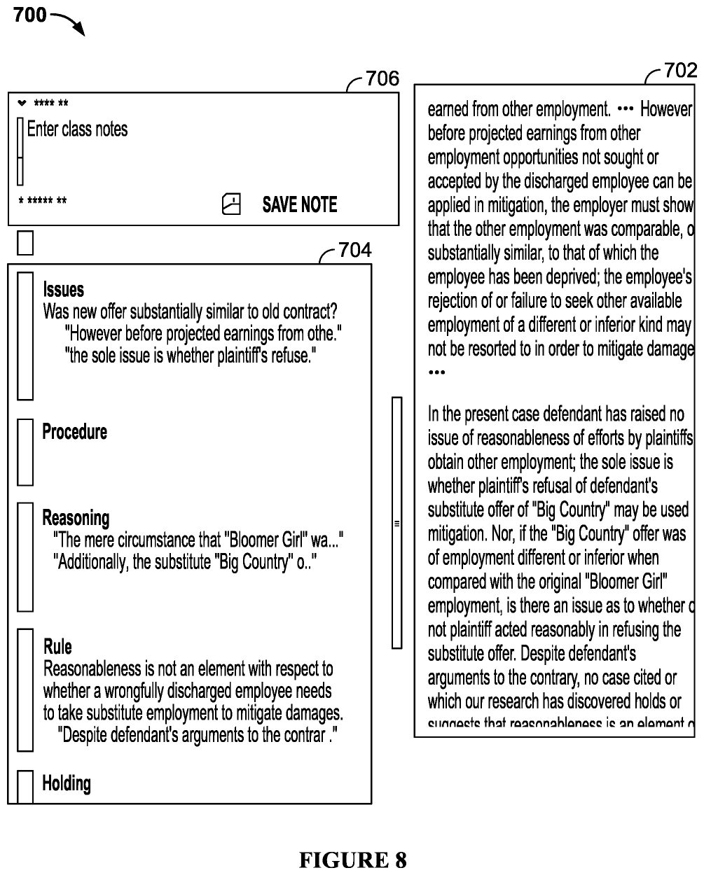

FIG. 8 illustrates an integrated view of source document 702 and a summary 704 in a split-screen display 700. The source document 702 includes the original digital text, media, web pages, or other content. As shown, the summary system can link the summarized information to the original information in the source document, and vice versa. This example also includes a notes area 706, for the user to input additional information.

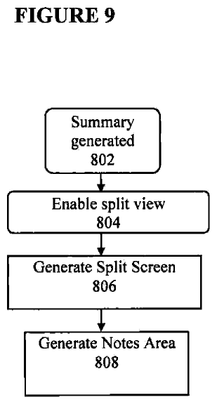

FIG. 9 is a flow diagram of a process for generating the split screen view of FIG. 8. At step 802, the server system 104 generates the summary, which can be in accordance with the process illustrated in FIG. 3. At step 804, the summary system enables the user to select a split view, such as by displaying a selection box to the user via the user device and sending a user selection to the system server 104. At step 806, the split screen is generated by the server system 104, and sent to the user device 102 to be displayed to the user. In generating the split screen, the summary system 100 can maintain the links between the source document and the user-identified information. Additionally, at step 808, the summary system can also generate the notes area 706, which can be sent to the user device 102 to be displayed to the user, where the user can input additional information.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A data summary system, comprising:
a user device including a user device processor and an input device;
a system server including:
a system memory configured to store program instructions;
a system processor configured to execute the program instructions to:
receive a first data set, the first data set including a user identifier, user-identified information, and custom information, the user-identified information including text selected from a source document, and the custom information associated with the user-identified information;
store the user-identified information and the custom information in the system memory at a location associated with the user identifier;
generate a summary in response to a user command received via the input device, the summary including the custom information and the user-identified information; and
generate an output in a split screen format, the split screen including the source document and the summary.

2. The data summary system of claim 1, wherein the custom information is prioritized relative to the user-identified information, such that the custom information is displayed above the user-identified information in the summary.

3. The data summary system of claim 1, further comprising:
a link between the user-identified information in the summary and the source document.

4. The data summary system of claim 1, further comprising:
a unique identifier associated with the user-identified information, wherein the unique identifier is selected from a unique identifier selection box.

5. The data summary system of claim 4, wherein the first data set further includes custom information associated with the unique identifier, and the program instructions, when executed, further cause the system processor to:
format the summary to include the custom information listed under the unique identifier.

6. The data summary system of claim 1, wherein the program instructions, when executed, further cause the system processor to:
link the user-identified information of the summary to corresponding original information of the source document.

7. The data summary system of claim 1, wherein the output generated includes a notes area for a user to input additional information.

8. The data summary system of claim 1, wherein the split screen format is generated in response to receiving a user selection indicating that the split screen format is selected.

9. A method of implementing a data summary system, comprising:
receiving a first data set by a processor of a system server, the first data set including a user identifier, user-identified information, and custom information, the user-identified information including text selected from a source document;
storing the user-identified information and the custom information in a system memory of the system server at a location associated with the user identifier;
generating a summary in response to a user command including the user-identified information and the custom information; and
providing the summary in a split screen view with the source document.

10. The method of claim 9, further comprising:
receiving an initial interaction from a client device that is coupled to the system server via the communication link; and
assigning and sending the user identifier to the client device in response to the initial interaction, wherein the user identifier associates the client device with a user profile stored in the system memory.

11. The method of claim 9, further comprising:
receiving with the first data set, a unique identifier associated with the text selected from the source document and being selected from a unique identifier selection box.

12. The method of claim 11, wherein the first data set further includes the custom information associated with the unique identifier, the method further comprising:
formatting the summary to include the custom information listed under the unique identifier.

13. The method of claim 9, further comprising:
receiving hyper-text transfer protocol (HTTP) requests by the processor via a communication link;
processing the HTTP requests to identify requested web pages included in a website database of the system server; and
providing the requested web pages in response to the HTTP requests by the processor via the communication link.

14. The method of claim 9, further comprising:
prioritizing the custom information relative to the user-identified information, such that the custom information is listed above the user-identified information in the summary.

15. The method of claim 9, further comprising:
linking the user-identified information of the summary to corresponding original information of the source document.

16. A data summary system, comprising:
a user device including a user device processor and an input device;
a system server comprising:
a system memory configured to store program instructions;
a system processor configured to execute the program instructions to:
receive a first data set via a communication link, the first data set including a user identifier, a first selection of user-identified information, and a first portion of custom information, the first selection of user-identified information including a first text selected from a first source document;
receive a second data set via the communication link, the second data set including the user-identifier, a second selection of user-identified information, and a second portion of custom information, the second selection of user-identified information including a second text selected from a second source document;
store the first selection of user-identified information, the first portion of custom information, the second selection of user-identified information, and the second portion of custom information in the system memory associated with the user identifier;
generate a first summary with the first selection of user-identified information and the first portion of custom information;
generate a second summary with the second selection of user-identified information and the second portion of custom information; and
generate an output in a split screen format, the split screen including the first source document and the second source document on a first side, and the first summary and the second summary on the second side.

17. The data summary system of claim 16, wherein the first data set includes a first unique identifier being associated with the first text and being selected from a first unique identifier selection box and the second data set includes a second unique identifier being associated with the second text and being selected from the second unique identifier selection box.

18. The data summary system of claim 17, wherein the first summary is generated to include the first portion of custom information underneath the first unique identifier and the second summary is generated to include the second portion of custom information underneath the second unique identifier.

19. The data summary system of claim 16, wherein the program instructions, when executed, further cause the system processor to:
aggregate the first summary and the second summary to produce an aggregated summary; and
providing the aggregated summary via a communication link.

20. The data summary system of claim 16, wherein the program instructions, when executed, further cause the system processor to:
link the first data set of the first selection of user-identified information of the first summary to corresponding original information of the first source document; and
link the second data set of the second selection of user-identified information of the second summary to the corresponding original information of the second source document.
